(19) United States
(12) Patent Application Publication
(10) Pub. No.: US 2024/0328903 A1
(43) Pub. Date: Oct. 3, 2024

(54) AUTOMATED ACOUSTIC ANOMALY DETECTION FEATURE DEPLOYED ON A PROGRAMMABLE LOGIC CONTROLLER

(71) Applicant: Siemens Aktiengesellschaft, Munich (DE)

(72) Inventors: Tao Cui, Princeton Junction, NJ (US); Jörg Claus, Karlsruhe (DE); Joseph Tylka, Pennington, NJ (US); Lingyun Wang, Princeton, NJ (US); Gustavo Arturo Quiros Araya, Orange, CT (US); Patrick Eisen, Princeton, NJ (US); Alessandra Oliveira Da Silva, Atlanta, GA (US)

(73) Assignee: Siemens Aktiengesellschaft, Munich (DE)

(21) Appl. No.: 18/681,530

(22) PCT Filed: Aug. 31, 2021
(86) PCT No.: PCT/US2021/048314

§ 371 Date: Feb. 6, 2024

(51) Int. Cl. G01M 99/00

(52) U.S. Cl. CPC G01M 99/005

(57) ABSTRACT

A real-time computer system for automated acoustic anomaly detection in a programmable logic controller (PLC) is disclosed, the computer system being deployed onto a backplane of the PLC. The computer system includes at least one processor with a real-time operating system and a memory having algorithmic modules stored thereon executable by the processor. The modules include a digital signal processing module configured to apply a windowing function to the sound signal data captured by a sensor, the sound signal data representative of sound emitted by an energized work product under quality inspection. The modules further include a feature extraction component configured to extract acoustic features from each sound window, and an anomaly detector module configured to operate a machine learning-based model to execute acoustic anomaly detection according to results of a classification operation on the acoustic features.

### TECHNICAL FIELD

This application relates to industrial controls. More particularly, this application relates to automated acoustic anomaly detection deployed on programmable logic controllers.

### BACKGROUND

State of the art acoustic anomaly detection in industry is performed by dedicated systems, such as Simcenter SCADAS XS by Siemens Digital Industries Software, with acoustic data acquisition (DAQ) capabilities. However, dedicated DAQ/audio systems have no direct connections to the factory automation system for allowing an integration with the entire automation process, such as industrial automation controllers or manufacturing execution systems (MES) for production and manufacturing. For example, the acoustic analysis often relies on human intervention, where an inspector must be physically present to listen to an energized product on the production line for whether the product passes the quality check. This intervention slows the process of production and introduces human error and subjectivity to the process. Moreover, expert knowledge is difficult to transfer to other inspectors for consistency and replication in quality checks across the product line.

### SUMMARY

System and method are provided for automated acoustic anomaly detection using programmable logic controllers (PLCs). In an aspect, the system and method are algorithmic and may be machine learning-based and fully integrated with a PLC system such that the acoustic detection is integrated with the entire factory automation system.

### BRIEF DESCRIPTION OF THE DRAWINGS

Non-limiting and non-exhaustive embodiments of the present embodiments are described with reference to the following FIGURES, wherein like reference numerals refer to like elements throughout the drawings unless otherwise specified.

FIG. 1 shows an example of a computer-based architecture for automated acoustic anomaly detection in accordance with embodiments of this disclosure.

FIG. 2 shows an example of interfacing with an artificial intelligence (AI) accelerator in accordance with embodiments of this disclosure.

FIG. 3 shows an example of AI accelerator architecture in accordance with embodiments of this disclosure.

FIG. 4 illustrates an example of a computing environment within which embodiments of the present disclosure may be implemented.

### DETAILED DESCRIPTION

Systems and methods are disclosed that enable acoustic anomaly detection in an industrial environment having full integration with a programmable logic controller (PLC). Based on acoustics of the product or machine in operation, a machine learning-based algorithm mimics a human quality inspector assessing the quality of the product or machine, capable of classifying acoustic emissions as either normal or anomalous, the latter indicating potential defects. The machine learning algorithm includes a signal processing aspect. The algorithm is deployed in industrial grade hardware specifically designed to assure real-time performance for deterministic control process deadlines, such as in the case of hard real-time cycled input/output signaling associated with PLC controlled drivers in an industrial automation system.

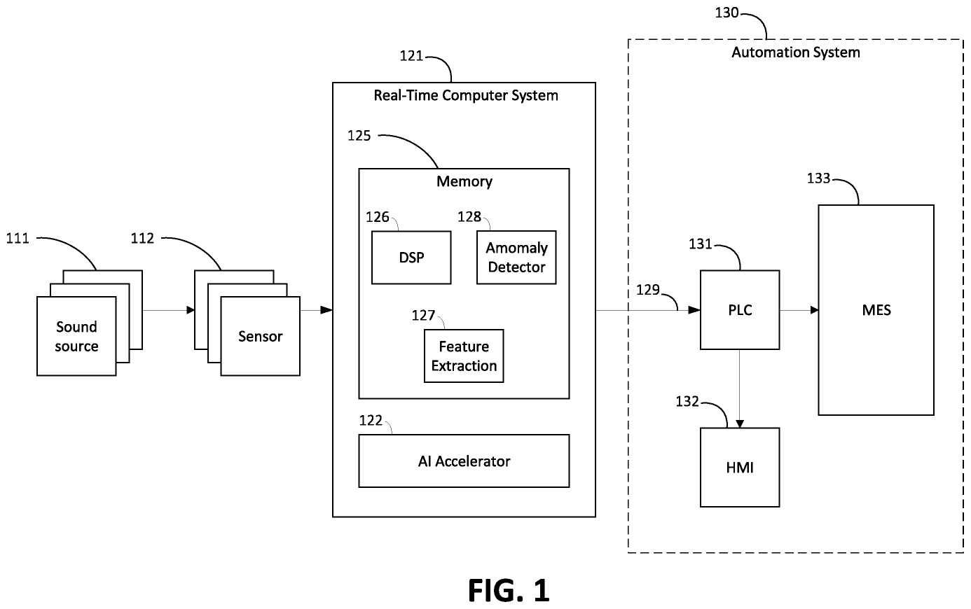

FIG. 1 shows an example of a computer-based architecture for automated acoustic anomaly detection in accordance with embodiments of this disclosure. In an embodiment, automated detection of acoustic anomalies is performed by a hard real-time computing system 121 that includes a machine learning-based anomaly detector module trained to learn acoustic characteristics of an energized work product under quality inspection. Once the training is completed, the computing device 121 can be deployed to a backplane 129 of an industrial controller, such as a programmable logic controller (PLC) 131. Acoustic anomaly detection is useful in industrial applications, such as for automation production line having a quality examination station for a mechanized work product that emits a detectable sound wave when energized or operated (e.g., a battery powered consumer product with a physical driver or motor). An objective of the automated anomaly detection system is for observed abnormal sound emissions (e.g., detectable by reading frequency spectrum response characteristics corresponding to human perception of a distinct noise feature, such as an unusual buzzing sound or other atypical sound quality) should register as an acoustic anomaly. Through machine learning-based modeling, the automated system can be trained to recognize whether an energized work product on the production line is satisfactory or defective.

For the example in FIG. 1, automation system 130 includes PLC 131, human machine interface (HMI) 132, and a manufacturing execution system (MES) 133, which control machine drivers (e.g., electro-mechanical drivers for conveyors and robots in the automated production line using hard real-time control programs that must guarantee response within specified time constraints or “deadlines”. Hard real-time computing is achieved by configuring computing device 121 with Artificial Intelligence (AI) accelerator 122. Examples of an AI accelerator include a neural processing unit (NPU), a tensor processing unit (TPU), a neural network processor (NNP), or an intelligence processing unit (IPU)).

In an embodiment, one or more sensors 112 detects a sound pattern emanating from one or more work products under inspection, shown as sound sources 111. For example, the anomaly detection operation of computing device 121 may operate on a set of work products at once, with the capability of identifying which of the devices is emitting an anomalous audio pattern and is potentially a defective device. In an aspect, audio capabilities of the AI accelerator 122 can compare wave run time to measure distance to each of multiple sensors 112, where each sensor is arranged to capture the raw audio data from a respective device being inspected. Hard real-time computing device 121 includes AI accelerator 122, which can be in the form of an embedded processor, with memory, processing units and real time operating systems to host applications including digital signal processing (DSP) module 126, feature extraction component 127, and anomaly detector 128.

In an aspect, the captured sound signal from sensor 112 (e.g., a microphone) fed into DSP module 126 which is configured to window the sound signal data. Feature extraction component 127 is configured to extract acoustic features from each sound data window. These extracted features mimic perception of sound by the human ear. For example, feature extraction component 127 may generate Mel-frequency cepstral coefficients (MFCC).

In an embodiment, anomaly detector 128 is a machine learning based model that takes acoustic features as the input and produces anomaly detection results: whether the captured sound includes a signature having an anomaly. For example, the model may be implemented as a classifier that uses a support vector machine (SVM) based on radial based function kernel. Other machine learning based classifiers, such as a 1-class classifier (e.g., healthy, unhealthy) can also be applicable.

Anomaly detector module 128 operates as a machine learning model that requires a training phase. Once training phase is completed, the model is ready for operating phase to execute the acoustic anomaly detection according to results of a classification operation on the acoustic features. In the training phase, an offline process includes feeding sound samples with labels (e.g., normal or abnormal) as training data inputs. The acoustic features from both normal and abnormal data window segments are calculated. Based on the acoustic features, the anomaly detector 128 is trained, validated, and tested. Other hyperparameters, such as parameters of the signal windowing or feature extraction calculations and machine learning anomaly detector model hyperparameters, are tuned so that the anomaly detector 128 can achieve the best performance on the data collected.

In the operating phase, the trained anomaly detector model and parameters are actively deployed onto the PLC 131 system by coupling the computing device 121 to the PLC 131 via backplane 129, such that the computing device 121 operates as an PLC module. The trained model with the parameters is pre-compiled for deployment such that the computation time is fixed for the repetitive use case. In this way, the model and computation are carried out deterministically within PLC's hard real-time cycle. This deployment extends a conventional PLC 131 to include acoustic functionality for acoustic anomaly detection, while ensuring the real time determinism of the PLC based automation system. As work products arrive at the inspection station, e.g., via an automated production line of conveyors and robotic arms, the sound characteristics of each work product are sensed by sensor 112 and the trained machine learning based model of anomaly detector 128 evaluates the MFCC's in hard real-time. The results are directly written to the PLC 131 for closed-loop control. An abnormal classification output of the anomaly detector is sent to PLC 131 as a data point input for controlling the automation system. For example, a control program of PLC 131 may be programmed to treat an abnormal classification as a detected acoustic anomaly and to respond with one or more trigger events, such as sending an alert for display on HMI 132 and/or routing, via PLC loop control signals, the work product to a path in the automated production line that performs remedial measures (e.g., further testing for specific diagnosis, repairs, or scrapping it as a faulty product).

In an embodiment, the real-time operating system of AI accelerator 122 is configured with a communication protocol compatible with PLC 131. As an example, for implementations that use a S7-1500 PLC, a compatible S7-1500 NPU module is selected for seamless integration with the PLC via the backplane. HMI 132 is configured to enable a user to operate an interactive automation software tool (e.g., TIA Portal). Consequently, once the computing device 121 is deployed onto PLC 131 via backplane 129, HMI 132 may be used as an interactive interface for a user to configure or reconfigure hyperparameters of anomaly detector 128 during operational iterations. The interactive automation software tool is configured to enable the user to edit a control program, reconfigure hyperparameters and control operation of the acoustic anomaly detection with windows-based editing features (e.g., drag and drop capability) in the same way that other I/O modules are editable for the PLC 131. HMI 132 may also enable user interaction for selecting remedial measures to be executed via control instructions from PLC 131.

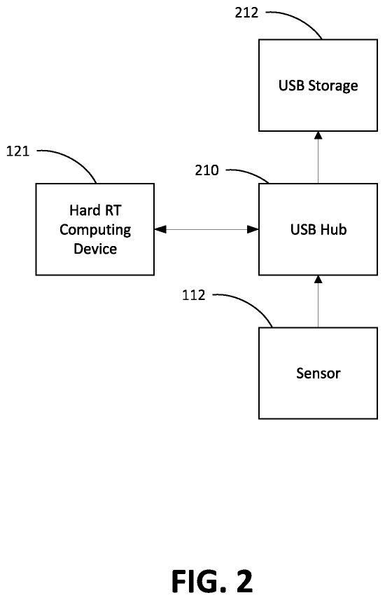

FIG. 2 shows an example of interfacing with the AI accelerator in accordance with embodiments of this disclosure. In an embodiment, a USB driver is integrated with a real-time operating system of AI accelerator 122, allowing the AI accelerator 122 to stream USB data from sensor 112 via a standard protocol (e.g., UAC1). The USB driver is configured to enable USB mass storage class to allow USB storage devices to be connected for data collection. In this way, the computing device 121 is enabled to connect to popular USB sensors (e.g., microphones) for real-time application. As shown in FIG. 2, a USB hub 210 is arranged to couple hard real-time computing device 121 to sensor 112 and to storage device 212. The USB driver controls streaming of sound data from sensor 112 and to computing device 121 and USB storage device 212 via USB hub 210.

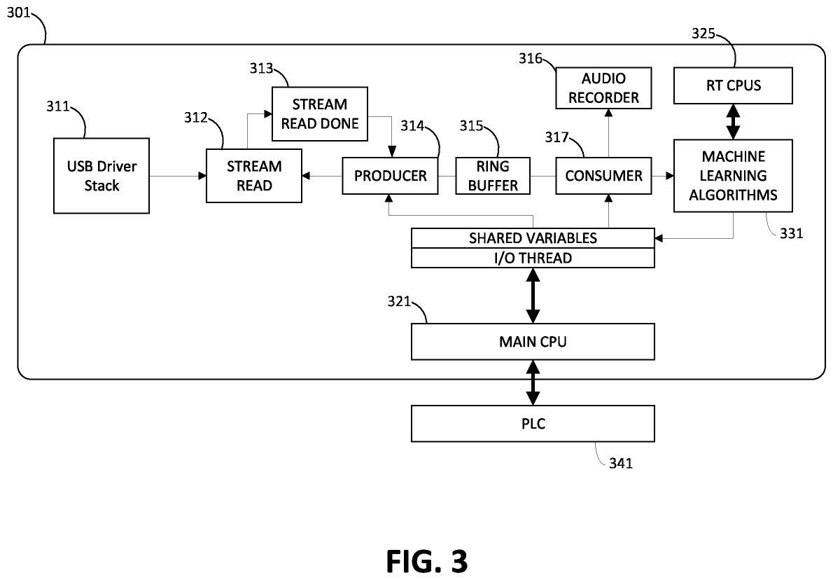

FIG. 3 shows an example of AI accelerator architecture in accordance with embodiments of this disclosure. In an embodiment, AI accelerator 122 as shown in FIGS. 1 and 2 is configured as AI accelerator 301 having multiple processors, including a main central processing unit (CPU) 321 with a heterogeneous multi-core Scalable Processor Architecture (SPARC) for embedded systems. The main CPU 321 operates the hard-real time tasks that integrated the acoustic functionality with the PLC control loop and interacts with the PLC 341 for real-time discrete control. The main CPU 321 operates a Portable Operating System Interface (POSIX) compliant real-time operating system (RTOS) (e.g., RTEMS), that allows the development of programs for hard real-time algorithms (e.g., through a software development kit (SDK)). Additional software stacks of the RTOS allow the AI accelerator 301 to communicate with the PLC 341 through the back plane in real-time. In an embodiment, the PLC 341 triggers the AI accelerator 301 to perform an anomaly detection (e.g., classification), in response to the PLC 341 detecting the product arrival for quality testing. In response, AI accelerator 301 sends the anomaly detection result back to the PLC 341 (e.g., as a feedback loop), and PLC 341 makes a decision on what to do with the product.

One or more real-time CPUs 325 operate the anomaly detector algorithms and host the audio pipeline that processes the USB stream of acoustic data, including the USB driver stack 311, buffering functionality provided by a stream read module 312, stream read done module 313, data producer module 314, ring buffer 315, data consumer module 317, and audio file recorder 316. A producer/consumer arrangement is a runtime software paradigm useful here for buffering multiple processes running at different speeds. In this example, data producer 314 drives the data production, assembles the high-speed streaming acoustic data, feeds data into the ring buffer 315 as it arrives. The data consumer 317 consumes data from the ring buffer 315 in windowed data chunks and drives the audio file recorder 316 and the machine learning algorithms 331. In this way, the fast-streaming data are completely captured, and are processed in the required windows size for audio recorder 316 and algorithms 331, which are operated at different rate than the acoustic data streaming. In an embodiment, shared variables include a sampling rate for the acoustic data, which is sent together with the acoustic data as it travels along the data buffering.

In an embodiment, the machine learning based acoustic anomaly detection algorithms 331 are executed by cores of CPUs 325. For example, one or more real-time CPUs 325 may be implemented with Streaming Hybrid Architecture Vector Engine (SHAVE) cores that employs a very large instruction words (VLIW) architecture, so that the computationally intensive algorithms, particularly neural network, can be compiled to and executed efficiently on massive parallel processing hardware in real-time. In this proposed architecture, the real-time acoustic data can be obtained and can be processed in real-time via the USB stack 311 and producer 314 to ensure the timely and complete high speed stream data capture. The computationally intensive tasks, such as the algorithms 331, are in the data consumer block 317 side for performing calculation runs in separate processes and can be reserved different CPU cores and resources to complete the tasks in hard real time cycle, and then directly writes back the results into the main CPU 321 and from there pass into the PLC control loop 341. The producer-consumer paradigm is an embodiment of the software architecture for the multi-processor system to ensure real time operation.

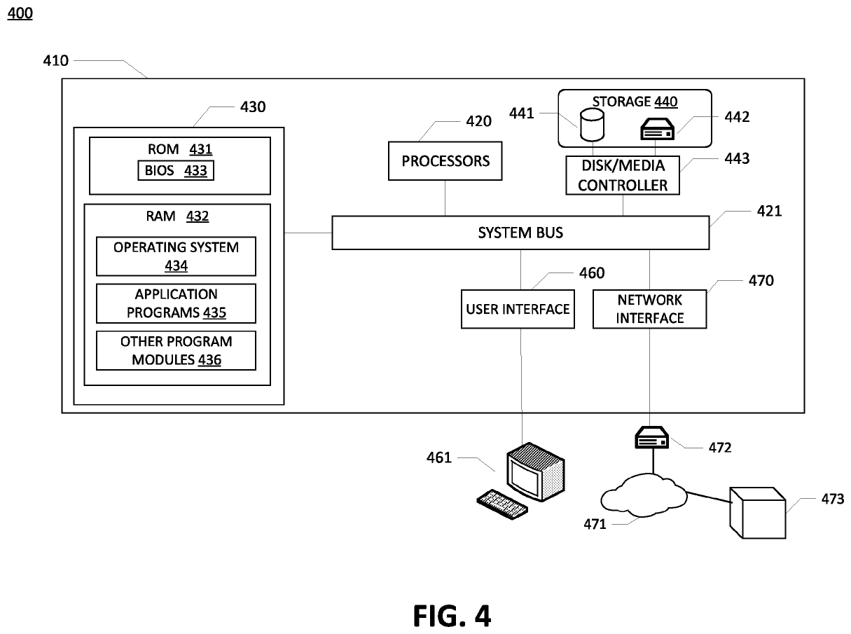

FIG. 4 illustrates an example of a computing environment within which embodiments of the present disclosure may be implemented. A computing environment 400 includes a computer system 410 that may include a communication mechanism such as a system bus 421 or other communication mechanism for communicating information within the computer system 410. The computer system 410 further includes one or more processors 420 coupled with the system bus 421 for processing the information. In an embodiment, computing environment 400 corresponds to a system for automated acoustic anomaly detection with hard real-time compliance for PLC deployment, in which the computer system 410 relates to a computer described below in greater detail.

The processors 420 may include one or more CPUs, as described above for CPUs 321, 325 of AI accelerator 301. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting, or transmitting information for use by an executable procedure or an information device, and/or by routing the information to an output device. A processor may use or comprise the capabilities of a computer, controller or microprocessor, for example, and be conditioned using executable instructions to perform special-purpose functions not performed by a general-purpose computer. The processor(s) 420 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 421 may include at least one of a system bus, a memory bus, an address bus, or a message bus, and may permit exchange of information (e.g., data (including computer-executable code), signaling, etc.) between various components of the computer system 410. The system bus 421 may include, without limitation, a memory bus or a memory controller, a peripheral bus, an accelerated graphics port, and so forth. The system bus 421 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 4, the computer system 410 may also include a system memory 430 coupled to the system bus 421 for storing information and instructions to be executed by processors 420. The system memory 430 may include computer readable storage media in the form of volatile and/or nonvolatile memory, such as read only memory (ROM) 431 and/or random access memory (RAM) 432. The RAM 432 may include other dynamic storage device(s) (e.g., dynamic RAM, static RAM, and synchronous DRAM). The ROM 431 may include other static storage device(s) (e.g., programmable ROM, erasable PROM, and electrically erasable PROM). In addition, the system memory 430 may be used for storing temporary variables or other intermediate information during the execution of instructions by the processors 420. A basic input/output system 433 (BIOS) containing the basic routines that help to transfer information between elements within computer system 410, such as during start-up, may be stored in the ROM 431. RAM 432 may contain data and/or program modules that are immediately accessible to and/or presently being operated on by the processors 420. System memory 430 additionally includes application modules 435 for executing the described embodiments, such as DSP module 126, feature extraction module 127 and anomaly detector 128 shown in FIG. 1.

The operating system 434 may be loaded into the memory 430 and may provide an interface between other application software executing on the computer system 410 and hardware resources of the computer system 410. More specifically, the operating system 434 may include a set of computer-executable instructions for managing hardware resources of the computer system 410 and for providing common services to other application programs (e.g., managing memory allocation among various application programs). In certain example embodiments, the operating system 438 may control execution of one or more of the program modules depicted as being stored in the data storage 440. The operating system 434 may include any operating system now known or which may be developed in the future including, but not limited to, any server operating system, any mainframe operating system, or any other proprietary or non-proprietary operating system.

The computer system 410 may also include a disk/media controller 443 coupled to the system bus 421 to control one or more storage devices for storing information and instructions, such as a magnetic hard disk 441 and/or a removable media drive 442 (e.g., floppy disk drive, compact disc drive, tape drive, flash drive, and/or solid-state drive). Storage devices 440 may be added to the computer system 410 using an appropriate device interface (e.g., a small computer system interface (SCSI), integrated device electronics (IDE), Universal Serial Bus (USB), or FireWire). Storage devices 441, 442 may be external to the computer system 410.

The computer system 410 may include a user interface 460 for communication with a graphical user interface (GUI) 461, which may comprise one or more input devices, such as a keyboard, touchscreen, tablet and/or a pointing device, for interacting with a computer user and providing information to the processors 420. In an aspect, the GUI 461 relates to an HMI for displaying alerts related to a detected acoustic anomaly as earlier described.

The computer system 410 may perform a portion or all of the processing steps of embodiments of the invention in response to the processors 420 executing one or more sequences of one or more instructions contained in a memory, such as the system memory 430. Such instructions may be read into the system memory 430 from another computer readable medium of storage 440, such as the magnetic hard disk 441 or the removable media drive 442. The magnetic hard disk 441 and/or removable media drive 442 may contain one or more data stores and data files used by embodiments of the present disclosure. The data store 440 may include, but are not limited to, databases (e.g., relational, object-oriented, etc.), file systems, flat files, distributed data stores in which data is stored on more than one node of a computer network, peer-to-peer network data stores, or the like. Data store contents and data files may be encrypted to improve security. The processors 420 may also be employed in a multi-processing arrangement to execute the one or more sequences of instructions contained in system memory 430. In alternative embodiments, hard-wired circuitry may be used in place of or in combination with software instructions. Thus, embodiments are not limited to any specific combination of hardware circuitry and software.

As stated above, the computer system 410 may include at least one computer readable medium or memory for holding instructions programmed according to embodiments of the invention and for containing data structures, tables, records, or other data described herein. The term “computer readable medium” as used herein refers to any medium that participates in providing instructions to the processors 420 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 441 or removable media drive 442. Non-limiting examples of volatile media include dynamic memory, such as system memory 430. Non-limiting examples of transmission media include coaxial cables, copper wire, and fiber optics, including the wires that make up the system bus 421. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 400 may further include the computer system 410 operating in a networked environment using logical connections to one or more remote computers, such as remote computing device 473. The network interface 470 may enable communication, for example, with other remote devices 473 or systems and/or the storage devices 441, 442 via the network 471. Remote computing device 473 may be a personal computer (laptop or desktop), a mobile device, a server, a router, a network PC, a peer device or other common network node, and typically includes many or all of the elements described above relative to computer system 410. When used in a networking environment, computer system 410 may include modem 472 for establishing communications over a network 471, such as the Internet. Modem 472 may be connected to system bus 421 via user network interface 470, or via another appropriate mechanism.

Network 471 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 410 and other computers (e.g., remote computing device 473). The network 471 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 471.

It should be appreciated that the program modules, applications, computer-executable instructions, code, or the like depicted in FIG. 4 as being stored in the system memory 430 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 410, the remote device 473, and/or hosted on other computing device(s) accessible via one or more of the network(s) 471, may be provided to support functionality provided by the program modules, applications, or computer-executable code depicted in FIG. 4 and/or additional or alternate functionality. Further, functionality may be modularized differently such that processing described as being supported collectively by the collection of program modules depicted in FIG. 4 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 4 may be implemented, at least partially, in hardware and/or firmware across any number of devices.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A real-time computer system for automated acoustic anomaly detection in a programmable logic controller (PLC), the computer system being deployed onto a backplane of the PLC, the computer system comprising:
at least one processor with a real-time operating system; and
a memory having algorithmic modules stored thereon executable by the processor, the modules comprising:
a digital signal processing module configured to window sound signal data captured by a sensor, the sound signal data representative of sound emitted by an energized work product under quality inspection;
a feature extraction component is configured to extract acoustic features from each sound window; and
an anomaly detector module configured to operate a machine learning-based model to execute acoustic anomaly detection according to results of a classification operation on the acoustic features.

2. The computer system of claim 1, wherein the acoustic features include Mel-frequency cepstral coefficients.

3. The computer system of claim 1, wherein the at least one processor is configured as an artificial intelligence accelerator comprising:
a main central processing unit (CPU) configured to operate the real-time operating system and interface with the PLC control loop; and
at least one real-time CPU configured to operate algorithms of the anomaly detector module and buffering of at least one of acoustic data variables, the sound signal data, the extracted acoustic features, or a combination thereof.

4. The computer system of claim 3, wherein the at least one real-time CPU includes Streaming Hybrid Architecture Vector Engine (SHAVE) cores that use a parallel processing unit specific for neural network evaluation in real-time.

5. The computer system of claim 1,
wherein the anomaly detector module is further configured to:
generate a normal classification or an abnormal classification for the acoustic features, and
send an abnormal classification as a data point input to the PLC for controlling the automation system; and
wherein the PLC is configured to:
treat the abnormal classification as a detected acoustic anomaly, and
respond with one or more trigger events.

6. The computer system of claim 5, wherein the trigger events include:
an alert for display on a human machine interface in response to an anomaly detection.

7. The computer system of claim 5, wherein the trigger events include:
route, via PLC loop control signals, the work product to a path in the automation production line that performs remedial measures.

8. The computer system of claim 1, wherein the modules further comprise:
a USB driver for controlling streaming of sound data received from the sensor.

9. A real-time computer-based method for automated acoustic anomaly detection in a programmable logic controller (PLC), the method comprising:
windowing sound signal data captured by a sensor, the sound signal data representative of sound emitted by an energized work product under quality inspection;
extracting acoustic features from each sound window; and
operating a machine learning-based model to execute acoustic anomaly detection according to results of a classification operation on the acoustic features.

10. The method of claim 1, wherein the acoustic features include Mel-frequency cepstral coefficients.

11. The method of claim 1,
generating a normal classification or an abnormal classification for the acoustic features;
sending an abnormal classification as a data point input to the PLC for controlling the automation system;
treating the abnormal classification as a detected acoustic anomaly; and
responding, by the PLC, with one or more trigger events.

12. The method of claim 11, wherein the trigger events include:
sending an alert for display on a human machine interface in response to an anomaly detection.

13. The method of claim 11, wherein the trigger events include:
routing, via PLC loop control signals, the work product to a path in the automation production line that performs remedial measures.

14. The method of claim 1,
using a USB driver for controlling streaming of sound data received from the sensor.
